(19) United States
(12) Patent Application Publication
(10) Pub. No.: US 2021/0114409 A1
(43) Pub. Date: Apr. 22, 2021

(54) Center Cap Decoupling Device

(71) Applicant: Wayne Dickherber, Foristell, MO (US)

(72) Inventor: Wayne Dickherber, Foristell, MO (US)

(21) Appl. No.: 16/660,400

(22) Filed: Oct. 22, 2019

(51) Int. Cl. B60B 31/06; B25B 27/00; B66F 15/00

(52) U.S. Cl. CPC B60B 31/06; B60B 2900/113; B66F 15/00; B25B 27/0035

(57) ABSTRACT

A center cap decoupling device for removing a center cap from a wheel hub includes a hook that is coupled to a first end of a cable. The hook is configured to be inserted into a slot that is positioned in a center cap that is coupled to a hub of a wheel. A coupler that is coupled to a second end of the cable is configured to selectively couple to a pry rod proximate to a first endpoint of the pry rod. A user positions a second endpoint of the pry rod on a tire proximate to a rim of the wheel. The cable is configured to transfer a force applied to the pry rod by the user to the hook to decouple the center cap from the hub. With the center cap removed, the lug nuts of the wheel are accessible to the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to decoupling devices and more particularly pertains to a new decoupling device for removing a center cap from a wheel hub.

### (2) Description of Related Art Including Information Disclosed Under 37 CFR 1.97 and 1.98

The prior art relates to decoupling devices.

### BRIEF SUMMARY OF THE INVENTION

An embodiment of the disclosure meets the needs presented above by generally comprising a hook that is coupled to a first end of a cable. The hook is configured to be inserted into a slot that is positioned in a center cap that is coupled to a hub of a wheel. A coupler that is coupled to a second end of the cable is configured to selectively couple to a pry rod proximate to a first endpoint of the pry rod. A user positions a second endpoint of the pry rod on a tire proximate to a rim of the wheel. The cable is configured to transfer a force applied to the pry rod by the user to the hook to decouple the center cap from the hub. With the center cap removed, the lug nuts of the wheel are accessible to the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a center cap decoupling device according to an embodiment of the disclosure.

FIG. 2 is a side view of an embodiment of the disclosure.

FIG. 3 is a cross-sectional view of an embodiment of the disclosure.

FIG. 4 is an in-use view of an embodiment of the disclosure.

FIG. 5 is an in-use view of an embodiment of the disclosure.

### DETAILED DESCRIPTION OF THE INVENTION

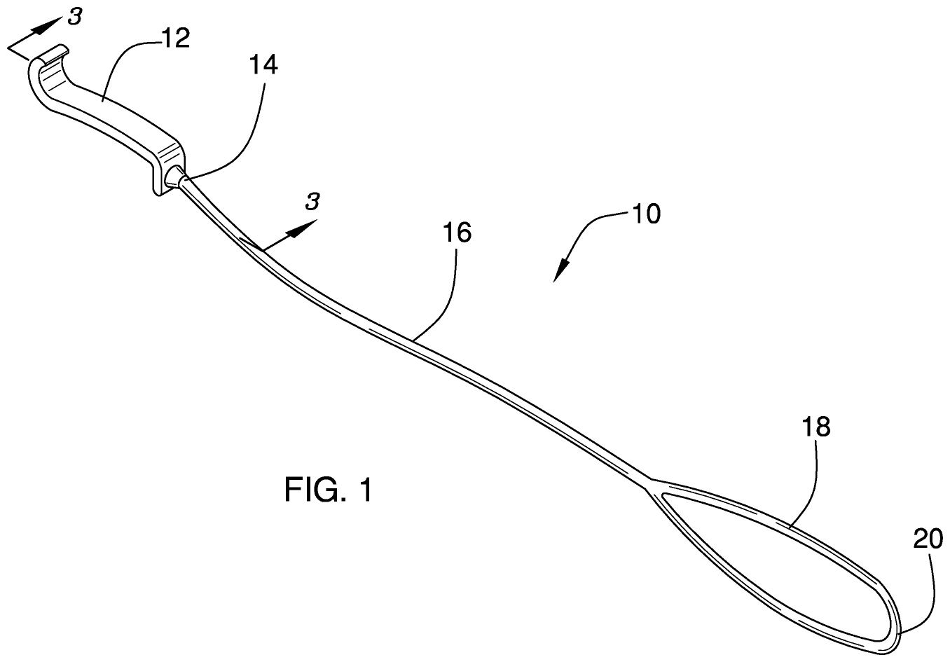

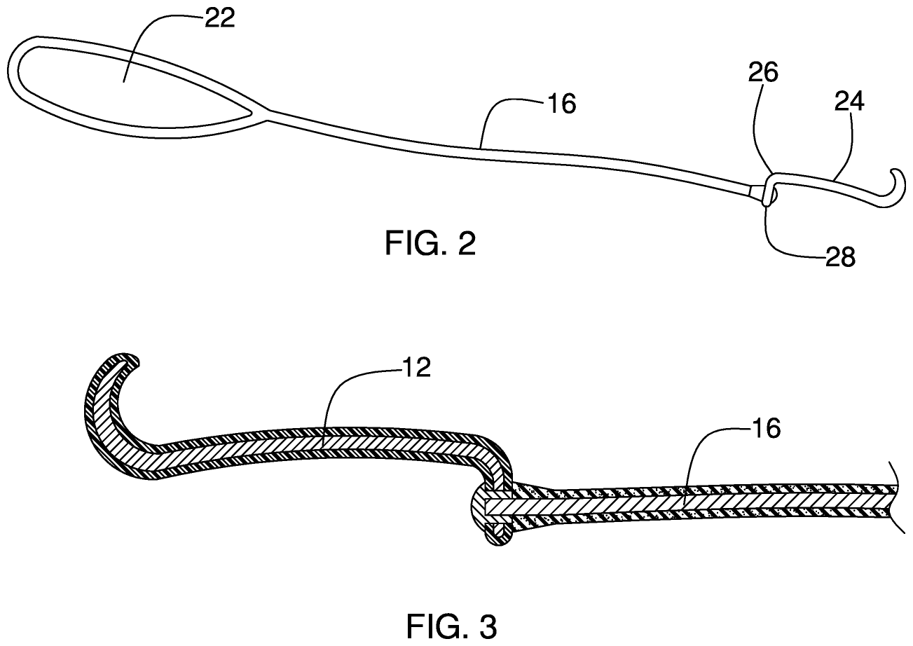

With reference now to the drawings, and in particular to FIGS. 1 through 5 thereof, a new decoupling device embodying the principles and concepts of an embodiment of the disclosure and generally designated by the reference numeral 10 will be described.

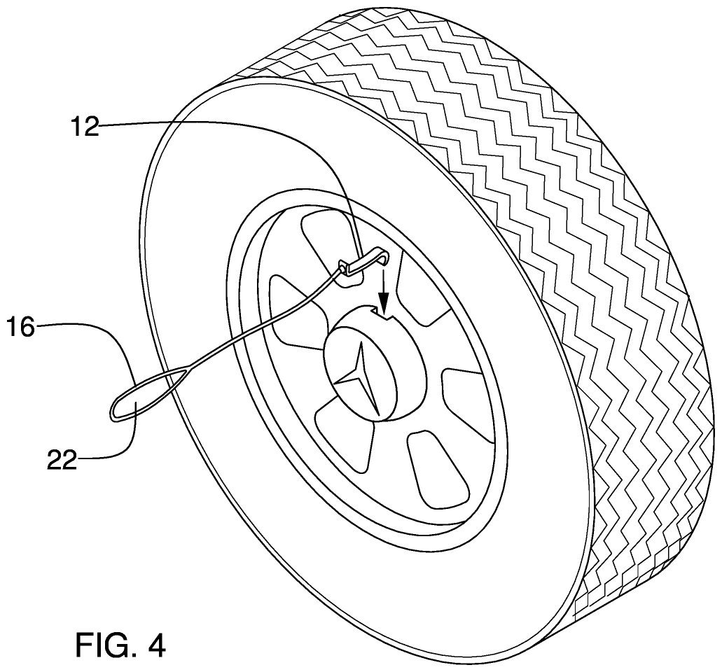

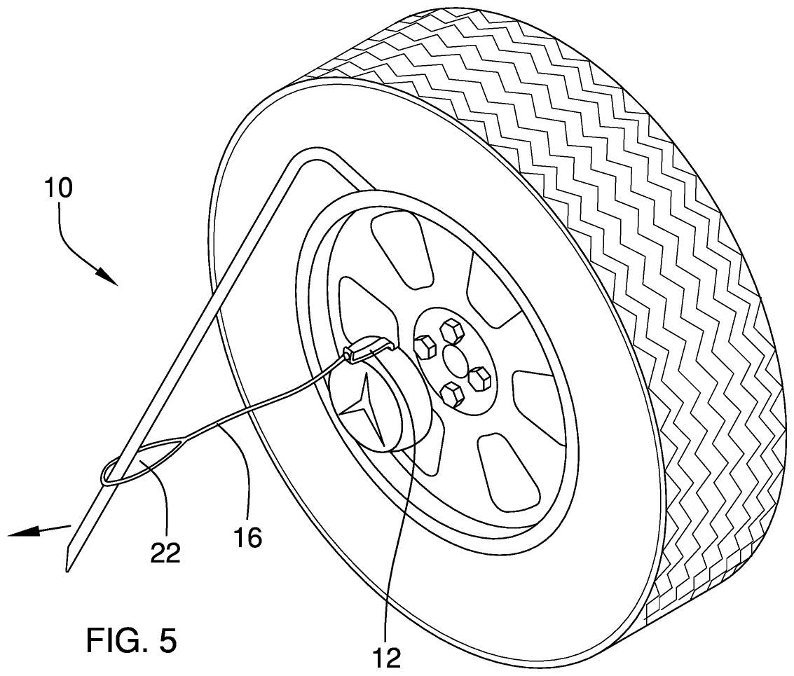

As best illustrated in FIGS. 1 through 5, the center cap decoupling device 10 generally comprises a hook 12 that is coupled to a first end 14 of a cable 16. The hook 12 is configured to be inserted into a slot that is positioned in a center cap that is coupled to a hub of a wheel of a vehicle, as shown in FIG. 4. The hook 12 and the cable 16 are coated with at least one of rubber, silicone, and plastic, as shown in FIG. 3. The hook 12 thus is configured to be coupled to the center cap without damaging the center cap or the hub, while the cable 16 is configured so as not to damage the hub. The hook 12 may comprise metal, or other rigid material, such as plastic and the like. The hook 12 comprises steel. The present invention also anticipates the cable 16 comprising other tethering means, such as, but not limited to, straps, ropes, and the like.

A coupler 18 that is coupled to a second end 20 of the cable 16 is configured to selectively couple to a pry rod proximate to a first endpoint of the pry rod. A user can then position a second endpoint of the pry rod on a tire proximate to a rim of the wheel. The cable 16 is configured to transfer a force that is applied to the pry rod by the user to the hook 12 to decouple the center cap from the hub, as shown in FIG. 5. With the center cap removed, the lug nuts of the wheel are accessible, and the user is positioned to remove the wheel from the vehicle. The coupler 18 may comprise a loop 22 that is positioned in the cable 16 adjacent to the second end 20, or other coupling means, such as, but not limited to, zip ties, hook and loop straps, clamps, and the like.

The hook 12 comprises a bar 24 that is arcuate distal from the cable 16 so that the bar 24 is configured to be hooked onto the center cap when inserted into the slot that is positioned in the center cap. A bend 26 is positioned in the bar 24 proximate to a first terminus 28 of the bar 24. The cable 16 is coupled to the bar 24 between the bend 26 and the first terminus 28. The bend 26 is configured to offset the force that is applied through the cable 16 to the hook 12 to enhance coupling of the hook 12 to the center cap. The bend 26 is substantially 90 degrees.

In use, the hook 12 is inserted into the slot that is positioned in the center cap. The pry rod is inserted through the loop 22 so that the cable 16 is coupled to the pry rod and so that the second end 20 of the pry rod is positioned on the tire proximate to the rim. The user then applies the force to the pry rod, with the force being transferred through the cable 16 to the hook 12. The center cap thus is decoupled from the hub.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A center cap decoupling device comprising:
a cable;
a hook coupled to a first end of the cable wherein the hook is configured for inserting into a slot positioned in a center cap coupled to a hub of a wheel of a vehicle; and
a coupler coupled to a second end of the cable, the coupler being configured for selectively coupling to a pry rod proximate to a first endpoint of the pry rod positioning a user for positioning a second endpoint of the pry rod on a tire proximate to a rim of the wheel wherein the cable is configured for transferring a force applied to the pry rod by the user to the hook for decoupling the center cap from the hub.

2. The device of claim 1, further including the cable being coated with at least one of rubber, silicone, and plastic.

3. The device of claim 1, further including the hook comprising a bar, the bar being arcuate distal from the cable such that the bar is configured for hooking onto the center cap when inserted into the slot positioned in the center cap.

4. The device of claim 1, further including the hook being coated with at least one of rubber, silicone, and plastic wherein the hook is configured for coupling to the center cap without damaging the center cap or the hub.

5. The device of claim 1, further including the hook comprising metal.

6. The device of claim 5, further including the hook comprising steel.

7. The device of claim 1, further including the coupler comprising a loop positioned in the cable adjacent to the second end.

8. The device of claim 3, further including a bend positioned in the bar proximate to a first terminus of the bar, the cable being coupled to the bar between the bend and the first terminus wherein the bend is configured for offsetting the force applied through the cable to the hook for enhancing coupling of the hook to the center cap.

9. The device of claim 8, further including the bend being substantially 90 degrees.

10. A center cap decoupling device comprising:
a cable, the cable being coated with at least one of rubber, silicone, and plastic;
a hook coupled to a first end of the cable wherein the hook is configured for inserting into a slot positioned in a center cap coupled to a hub of a wheel of a vehicle, the hook comprising a bar, the bar being arcuate distal from the cable such that the bar is configured for hooking onto the center cap when inserted into the slot positioned in the center cap, the hook being coated with at least one of rubber, silicone, and plastic wherein the hook is configured for coupling to the center cap without damaging the center cap or the hub, the hook comprising metal, the hook comprising steel;
a coupler coupled to a second end of the cable, the coupler being configured for selectively coupling to a pry rod proximate to a first endpoint of the pry rod positioning a user for positioning a second endpoint of the pry rod on a tire proximate to a rim of the wheel wherein the cable is configured for transferring a force applied to the pry rod by the user to the hook for decoupling the center cap from the hub, the coupler comprising a loop positioned in the cable adjacent to the second end; and
a bend positioned in the bar proximate to a first terminus of the bar, the cable being coupled to the bar between the bend and the first terminus wherein the bend is configured for offsetting the force applied through the cable to the hook for enhancing coupling of the hook to the center cap, the bend being substantially 90 degrees.
